(19) United States
(12) Patent Application Publication
(10) Pub. No.: US 2004/0106508 A1
(43) Pub. Date: Jun. 3, 2004

(54) Ceramics-containing dispersant, a method for producing same and the use of said dispersant in thick-film pastes

(76) Inventors: Gerd Scheying, Stuttgart (DE); Ingrid Wuehrl, Gerlingen (DE); Petra Kuschel, Leonberg (DE)

Correspondence Address: KENYON & KENYON, ONE BROADWAY, NEW YORK, NY, 10004, US

(21) Appl. No.: 10/149,938

(22) PCT Filed: Dec. 7, 2000
(86) PCT No.: PCT/DE00/04354

(51) Int. Cl. C04B 35/52

(52) U.S. Cl. 501/99

(57) ABSTRACT

A ceramic-containing disperse substance is proposed, having a ceramic component, a solvent and a dispersing agent, the ceramic component being present at least largely in the form of primary particles having an average particle size of 5 nm to 50 nm. The ceramic component in the material further has a specific surface of 20 m²/g to 120 m²/g. Besides that, a method for producing this disperse substance is proposed, the ceramic starting component being submitted to a preparation step together with the dispersing agent and the solvent, by which the average particle size of the ceramic starting powder is reduced, so that the ceramic-containing disperse substance is created. The proposed disperse substance is suitable, together with an additionally added binding agent and a plasticizer, especially for use in thick-film pastes such as the ones used in screen-printing methods or for the production of ceramics fired in a post-firing method.

The present invention relates to a ceramic-containing disperse substance, a method for producing this ceramic-containing disperse substance, as well as its use in the production of thick-film pastes, according to the species defined in the main claim.

### BACKGROUND INFORMATION

In the production of exhaust gas sensors, sintering ceramic substrates at temperatures greater than 1300° C. is known. At present, starting materials in the form of ceramic powders are used, having specific surfaces less than 15 m²/g.

It is further known that one may work into a thick-film metal paste a ceramic component as supporting structure, and use for that powders having specific surfaces <10 m²/g.

Finally, it is also known that one may produce metal and mixed-conductor electrodes using such ceramic materials, whereas, up to the present, the usable surface, which has a powerful effect on accessibility to the so-called three-phase boundary of gas, metal and electrolyte, is reduced to such an extent by the high temperature of more than 1300° C. for the sintering processes used, that sensors produced by these processes suffer a loss in sensitivity.

### SUMMARY OF THE INVENTION

The ceramic-containing disperse substance according to the present invention, the method according to the present invention for producing this disperse substance and its use, according to the present invention, in thick-film pastes have the advantage compared to the related art that using them, low-sintering substrates, such as for solid electrolytes, may be produced. In particular, the sintering temperature required for such substrates may be reduced to ca 1100° C.

It is also of advantage that the sensitivity of electrodes in sensors is increased by the thick-film paste made with the disperse substance.

Since the nano-scale ceramic component is present in the ceramic disperse substance in redispersible form, the disperse substance can also be worked into a thick-film paste in a simple way, without an additional costly dispersion going beyond the usual measures.

The thick-film paste produced has the advantage that, because of the nano-scale ceramic supporting structure contained in it, a sintering connection is achieved, even at sintering temperatures of about 1000° C., between a substrate and the ceramic component of the thick-film paste, or rather the ceramic supporting structure, applied to the substrate by supporting structure is meant in this case the ceramic component in a cermet layer which firmly sinters to the bordering ceramic layer of the substrate.

Advantageously, now, pastes having metal powder may also be worked into such a thick-film paste, which are fired in a so-called post-firing method.

Such pastes of metal powders, which, for example may have gold as electrode material for mixed potential sensors, may typically be fired at temperatures of maximally ca 1000° C., because otherwise the metal would melt. Because the ceramic component in the ceramic-containing disperse substance, which has been worked into the thick-film paste, sinters at clearly lower temperatures than do ceramic-containing materials known from the related art, when such a thick-film paste is applied, for instance, to a ceramic substrate, optimal sintering connection and an open-pore condition are ensured, even at a temperature of ca 1000° C. That is why a thick-film paste made with this disperse substance is particularly suitable also for sensor electrodes having increased sensitivity.

By the way, it is advantageous that such a thick-film paste may also be used as a functional layer, for example, in gas-sensitive electrodes. For this purpose, the disperse substance according to the present invention is prepared using a disperser, a binding agent and a plasticizer being added to the ceramic-containing material. In this manner, the viscosity of the thick-film paste may further be set in a simple way at the same time.

Advantageous further refinements of the present invention result from the measures indicated in the dependent claims.

Thus, the ceramic-containing disperse substance according to the present invention and the thick-film paste made with the use of this disperse substance are particularly suitable for processing using a screen-printing method, when producing ceramic and metal-containing functional layers fired in a post-firing method, for producing ceramic substrates or sensors having a low sintering temperature, for producing metal-containing thick-film pastes as well as solid electrolyte layers or electrodes in gas sensors such as oxygen sensors (lambda probe), mixed potential sensors or, in general, sensors having gas-selective layers.

### DESCRIPTION OF THE EXEMPLARY EMBODIMENTS

In order to produce the ceramic-containing disperse substance, a ceramic powder-form starting material is first mixed with a solvent and a dispersing agent. The powder-form ceramic starting component used has a specific surface of 15 m²/g to 120 m²/g, preferably 40 m²/g to 100 m²/g. As ceramic component, a metal oxide, a metal nitride, a metal carbide or a mixture of these materials are especially suitable. Particularly suitable are zirconium dioxide, yttrium-stabilized zirconium dioxide, titanium dioxide, yttrium dioxide, titanium carbide, silicon carbide, silicon dioxide or aluminum oxide.

For the solvent, preferably a high-boiling solvent such as alpha-terpineol or diethyleneglycolmonobutylether is used. In this connection, a solvent is considered to be high-boiling if it is temperature-stable or does not evaporate up to at least 80° C., preferably up to at least 100° C.

By using the high-boiling solvent it is intended to avoid having the solvent volatilize during the preparation step explained below, which is of necessity involved with a temperature increase. In addition, the solvent acts as a suspension component or suspension agent for the ceramic component.

Incidentally, in place of a high-boiling solvent, another solvent such as acetone can also be used. But in that case, it must be ensured that the solvent evaporating during the preparation step is, for example, continuously refilled or replaced from time to time.

As dispersing agent, an organic acid, particularly a water-miscible, long chain organic acid such as trioxadecanoic acid is used. As an alternative, however, decanoic acid, lauric acid or, in principal, any other organic acid having a carboxyl group and a carbon chain of 3 to 20 carbon atoms may partially be used.

Furthermore, the dispersing agent is added in an amount of 2.5 μmol/m² to 15 μmol/m² in terms of the surface of the ceramic powder-form components.

Finally, the proportion of solvent in the ceramic-containing disperse substance is preferably chosen so that the ceramic component in the disperse substance takes up a proportion of more than 40% by volume, particularly 50% to 60% by volume.

For the production of the ceramic-containing disperse substance, the powder-form ceramic starting component is first mixed together with the dispersing agent and the solvent in a kneading machine. In this context, the ceramic starting component first has an average aggregate or agglomerate size of 70 nm to over 1000 nm. Subsequently, a preparation step is undertaken with this mixture, by which the average particle or agglomerate size of the ceramic starting powder is reduced at least largely to its primary particle size of 5 nm to 50 nm.

The preparation step is carried out in detail by kneading the powder-form ceramic starting component, the dispersing agent and the solvent in an automatic kneader for a time period of, for instance, 20 min to 3 h. During this kneading in the automatic kneader it is important that the kneaded starting material is submitted to shearing forces that are as high as possible. This is secured because of the high proportion of the ceramic component of more than 40% in the D.

It is the aim of the preparation step to shear the powder-form ceramic particles of the ceramic starting component so strongly that agglomerates break up, and that thereby the average particle size is clearly reduced. Because of the dispersing agent used, after the breaking up of the agglomerate, the ceramic powder particles are further protected from reagglomeration, so that the ceramic-containing disperse substance obtained after the preparation step may be very easily redispersed, and may be used as a so-called master batch for a further processing. In particular, the ceramic particles are now present in the disperse substance at least largely as primary particles, after the preparation step.

Furthermore, in order to produce a thick-film paste using the explained ceramic-containing disperse substance, a binding agent and a plasticizer are added to the disperse substance in a known manner.

For this purpose, the ceramic-containing disperse substance is processed with the binding agent and the plasticizer in a usual paste-producing method, that is, for example, dispersed by a roller mill or a disperser.

By the addition of the binding agent and the plasticizer, the viscosity of the thick-film paste may be set in a simple manner. That is why such a thick-film paste can also be used in screen-printing methods, by setting a correspondingly low viscosity.

Incidentally, the thick-film paste explained above may also have an additional metallic paste component added to it as needed, for instance, in the form of a metallic powder. Powdered gold, powdered platinum or powdered palladium are particularly suitable as the metal powder.

By the way, the binding agent used in the thick-film paste is preferably an oligomeric or a polymeric binding agent, such as ethylcellulose or polyvinylbutyral. Phthalates, a sebaceate, glycolether or alpha-terpineol are suitable as plasticizer.

What is claimed is:

1. A ceramic-containing disperse substance having at least one ceramic component, a solvent and a dispersing agent,
wherein the ceramic component is present in the disperse substance at least largely in the form of primary particles having an average particle size between 5 nm and 50 nm; and the specific surface of the ceramic component is 20 m²/g through 120 m²/g.

2. The ceramic-containing disperse substance as recited in claim 1,
wherein the ceramic component contains a metal oxide, metal nitride or metal carbide, especially zirconium dioxide, yttrium-stabilized zirconium dioxide, titanium dioxide, silicon dioxide or aluminum oxide or a mixture of these substances.

3. The ceramic-containing disperse substance as recited in claim 1 or 2,
wherein the solvent is a high-boiling solvent, especially alpha-terpineol or diethyleneglycolmonobutylether.

4. The ceramic-containing disperse substance as recited in claim 1,
wherein the dispersing agent is an organic acid, especially a water-miscible long-chain acid, such as trioxadecanoic acid or decanoic acid or lauric acid.

5. The ceramic-containing disperse substance as recited in at least one of the preceding claims,
wherein the dispersing agent is applied in an amount of 2.5 μmol/m² through 15 μmol/m² in terms of the surface of the ceramic component.

6. The ceramic-containing disperse substance as recited in at least one of the preceding claims,
wherein the ceramic component is applied in a proportion of more than 40% by volume, particularly 50% to 60% by volume.

7. A method for producing a ceramic-containing disperse substance having at least one powder-form ceramic starting component, a dispersing agent and a solvent,
wherein the ceramic starting component is submitted to a preparation step, together with the dispersing agent and the solvent, by which the average aggregate size of the ceramic starting component is reduced.

8. The method as recited in claim 7,
wherein the ceramic starting component is first applied having an average aggregate size of 70 nm to 2000 nm which is reduced to an average primary particle size of 5 nm to 50 nm during the preparation step.

9. The method as recited in claim 7 or 8,
wherein the preparation step includes kneading the powder-form ceramic starting component, the dispersing agent and the solvent.

10. The method as recited in claim 9,
wherein the kneading is performed in a force-fed kneader over a time period of 20 min to 3 h.

11. The use of the ceramic disperse substance as recited in at least one of claims 1 through 6 for producing a thick-film paste, particularly for use in screen-printing or in the production of ceramics fired in a post-firing method.
